(19) United States
(12) Patent Application Publication
(10) Pub. No.: US 2024/0023575 A1
(43) Pub. Date: Jan. 25, 2024

(54) Ozone Sanitization System and Method for Animal Feed

(71) Applicant: BioSec Pathogen Protection LLC, North Miami, FL (US)

(72) Inventor: Mark Paul Kollasch, Silver Springs, MD (US)

(73) Assignee: BioSec Pathogen Protection LLC, North Miami, FL (US)

(21) Appl. No.: 18/356,812

(22) Filed: Jul. 21, 2023

Related U.S. Application Data
(60) Provisional application No. 63/391,532, filed on Jul. 22, 2022.

(51) Int. Cl. A23K 30/00; A23N 17/00; B01F 27/724; B01F 23/30; C01B 13/11

(52) U.S. Cl. CPC A23K 30/00; A23N 17/001; B01F 27/724; B01F 23/34; C01B 13/11; B01F 2101/18

(57) ABSTRACT

An ozone supply device is described for generating ozone and supplying the ozone to a livestock feed system for application to livestock feed to sanitize the feed. The device includes an intake port for receiving air from outside the device, an ozone generator for receiving air from the intake port and converting oxygen in the air to ozone, an ozone compressor intake for receiving ozone produced by the ozone generator, a compressor pump for compressing ozone received through the ozone compressor intake, and an ozone supply line for transmitting compressed ozone to a livestock feed system for application to the livestock feed. The device also includes an ozone meter and display, a timer, an inverter, and one or more housings. An adapter is interconnectable between the livestock feed system and the ozone supply line of the ozone supply device to connect them together.

### CROSS-REFERENCE TO RELATED APPLICATIONS

This application is a nonprovisional application of and claims priority from U.S. provisional patent application Ser. No. 63/391,532 filed on Jul. 22, 2022. The foregoing application is incorporated in its entirety herein by reference.

### FIELD OF THE INVENTION

The invention relates to devices, systems, and methods for using ozone or another sanitizing gas to sanitize animal feed, grain, or other food or non-food items. More particularly, the invention relates to a sanitization system that supplies ozone or another sanitizing gas to a livestock feed system to sanitize the feed or to another enclosed augur or conveyor system for transporting grain or other items requiring sanitization.

### BACKGROUND

Livestock feed systems are used in modern agricultural methods to transport and supply livestock feed such as grains or processed feeds to livestock. Augur and conveyor systems are also used to transport grain, produce (i.e., fruits and vegetables), other food items, and non-food items. Livestock feed and such other food and non-food items may become contaminated with various pathogens during production, transport, storage, or distribution. Conventional livestock feed systems, augur systems, and conveyor systems do not include any means for sanitizing or disinfecting livestock feed and other items transported via such systems to kill or suppress the growth of bacteria, viruses, fungi, and other pathogens.

A need exists for systems and methods that sanitize livestock feed and other food and non-food items to kill or suppress the growth of pathogens therein before it is consumed or otherwise used by animals or humans.

### SUMMARY

The invention relates to an ozone supply device for generating ozone and supplying the ozone to a livestock feed system for application to livestock feed to sanitize the feed. The invention also relates to similar sanitization systems for supplying ozone or another sanitizing gas to an augur or conveyor system (e.g., an enclosed augur or conveyor system from which gas cannot escape) for application to livestock feed, grain, produce (i.e., fruits and vegetables), other food items, and non-food items to sanitize such items. In some embodiments, a sanitizing gas other than ozone or a combination of ozone and one or more other sanitizing gases may be used. For purposes of convenience, but not as a limitation, ozone is referred to herein as the sanitizing gas with the understanding that other sanitizing gases may be used in lieu of or in combination with ozone. The device includes an intake port for receiving air from outside the device, an ozone generator for receiving air from the intake port and converting oxygen in the air to ozone, an ozone compressor intake for receiving ozone produced by the ozone generator, a compressor pump for compressing ozone received through the ozone compressor intake, and an ozone supply line for transmitting compressed ozone to a livestock feed system for application to the livestock feed. The device also includes an ozone meter and display, a timer, an inverter, and one or more housings.

The invention also relates to an ozone sanitization system that includes a livestock feed system and an ozone supply device that is integrated therewith (e.g., by an adapter) to generate ozone and supply the ozone to the livestock feed system for application to livestock feed to sanitize the feed.

The ozone sanitization system can also include an ultraviolet-C light system installed within a transitional hopper that is integrated into the livestock feed system to further sanitize the livestock feed.

The devices, systems, and methods described herein provide an advantage by sanitizing livestock feed before it is distributed to livestock for consumption. Another advantage of the devices, systems, and methods described herein is the ability to infuse feed with a sanitizing gas through integration with existing livestock feed systems. Still another advantage of the devices, systems, and methods described herein is the ability to sanitize livestock feed with efficient and inexpensive ozone, ultraviolet-C light, or both before the feed is distributed to livestock for consumption.

Accordingly, the invention features a system for sanitizing livestock feed. The system includes an ozone supply device, a livestock feed system, and an adapter for connecting the ozone supply device to the livestock feed system. The ozone supply device includes an intake port for receiving oxygen from a source of oxygen (02), an ozone generator for receiving the oxygen from the intake port and converting the oxygen to ozone, an ozone compressor intake for receiving ozone produced by the ozone generator, a compressor pump for compressing ozone received through the ozone compressor intake, and an ozone supply line for transmitting compressed ozone to a livestock feed system for application to livestock feed. The livestock feed system includes a conduit for transporting livestock feed from a container to a feeding station, and an agitating device installed within a pipe to agitate the livestock feed to increase infusion of ozone into the livestock feed for sanitization. The adapter connects the ozone supply line of the ozone supply device to the conduit of the livestock feed system.

In another aspect, the invention can feature the system further including a filter installed over the intake port.

In another aspect, the invention can feature the agitating device including or being an augur system; wherein the augur system includes an augur installed inside the conduit; and wherein the augur is connected at a first end to a drive motor for rotating the augur within the conduit.

In another aspect, the invention can feature the livestock feed system including a hopper; wherein the conduit includes a first end and a second end; and wherein the conduit is connected at the first end to the container holding the livestock feed and at the second end to the hopper above an interior bottom surface of the hopper.

In another aspect, the invention can feature a first end of the ozone supply line being communicatively connected to the compressor pump and a second end of the ozone supply line being communicatively connected to the hopper above the interior bottom surface of the hopper so that ozone is infused into the livestock feed as it exits the second end of the pipe and falls through an interior space of the hopper to the interior bottom surface.

In another aspect, the invention can feature the system further including ultraviolet lighting for sanitizing the livestock feed as it passes through the livestock feed system.

In another aspect, the invention can feature the system further including ultraviolet lighting for sanitizing the livestock feed as it passes through the livestock feed system; wherein the ultraviolet lighting is installed in the hopper.

The invention also features a system for sanitizing livestock feed. The system includes a livestock feed system for transporting livestock feed and an ozone supply device. The ozone supply device includes an intake port for receiving air from outside the device, an ozone generator for receiving air from the intake port and converting oxygen in the air to ozone, an ozone compressor intake for receiving ozone produced by the ozone generator, a compressor pump for compressing ozone received through the ozone compressor intake, and an ozone supply line for transmitting compressed ozone into the livestock feed system for application to the livestock feed.

In another aspect, the invention can feature the livestock feed system being or including an augur system installed within a pipe to turn and agitate the livestock feed; wherein the augur system includes an augur installed inside the pipe; and wherein the augur is connected at a first end to a drive motor for rotating the augur.

In another aspect, the invention can feature the livestock feed system applying the compressed ozone to the livestock feed as the livestock feed is agitated by the augur system.

In another aspect, the invention can feature the ozone supply line including a main line and at least one capillary line; wherein the main line is connected at a first end to the compressor pump and extends generally in parallel along at least a portion of a pipe of the livestock feed system; and wherein each at least one capillary line communicatively connects at a first end to the main line and at a second end to the pipe of the livestock feed system.

In another aspect, the invention can feature the at least one capillary line including a plurality of capillary lines, wherein the second end of each of the plurality of capillary lines communicatively connects to the pipe of the livestock feed system.

In another aspect, the invention can feature compressed ozone being pumped from the compressor pump through a main line of the ozone supply line, from the main line into at least one capillary line, and from the at least one capillary line into a pipe of the livestock feed system for application to the livestock feed.

In another aspect, the invention can feature the livestock feed system further including a hopper; wherein the pipe of the augur system includes a first end and a second end; and wherein the pipe is connected at the first end to the container holding the livestock feed and at the second end to the hopper above an interior bottom surface of the hopper.

In another aspect, the invention can feature a first end of the ozone supply line being communicatively connected to the compressor pump and a second end of the ozone supply line being communicatively connected to the hopper above the interior bottom surface of the hopper so that ozone is infused into the livestock feed as it exits the second end of the pipe and falls through an interior space of the hopper to the interior bottom surface.

In another aspect, the invention can feature the system further including an adapter interconnecting between the livestock feed system and the ozone supply line of the ozone supply device for transmission of compressed ozone from the ozone supply line into the livestock feed system for application to the livestock feed as the livestock feed is agitated by an agitating device.

In another aspect, the invention can feature the agitating device being or including an augur system having a pipe for transporting livestock feed from a container to a feeding station, an augur installed within the pipe, and a motor to turn the augur within the pipe to agitate the livestock feed for increasing infusion of the compressed ozone in the livestock feed.

In another aspect, the invention can feature the system further including ultraviolet lighting for sanitizing the livestock feed as it passes through the livestock feed system.

A method of the invention can be used for sanitizing livestock feed. The method includes the steps of: (a) transporting livestock feed from a container through a conduit; (b) agitating the livestock feed as it passes through the conduit; and (c) applying a sanitizing gas to the livestock feed as it is agitated within the conduit to sanitize the livestock feed.

Another method of the invention can include the step of: (d) dispensing the sanitized livestock feed at a feeding station.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a front elevation view of an ozone supply device of a system for sanitizing livestock feed.

FIG. 2 is a side elevation view of the ozone supply device of FIG. 1.

FIG. 3 is a cut-away side elevation view of the ozone supply device of FIG. 1.

FIG. 4 is a cut-away front elevation view of the ozone supply device of FIG. 1.

FIG. 5 is a cut-away front elevation view of the ozone supply device of FIG. 1 illustrating the flow of oxygen into an oxygen chamber of a housing of the device and converted to ozone by an ozone generator for release into an ozone chamber of the housing.

FIG. 6A is a cross-sectional view of an augur system of a conventional livestock feed system without livestock feed in a pipe of the livestock feed system.

FIG. 6B is a cross-sectional view of the augur system of FIG. 6A with livestock feed in the pipe of the livestock feed system.

FIG. 7A is a cross-sectional view of an augur system of a livestock feed system of the system for sanitizing livestock feed without livestock feed in a pipe of the livestock feed system, wherein an empty ozone supply line is connected to the pipe.

FIG. 7B is a cross-sectional view of the augur system of FIG. 7A with livestock feed in the pipe of the livestock feed system, wherein the empty ozone supply line is connected to the pipe.

FIG. 7C is a cross-sectional view of the augur system of FIG. 7A with livestock feed in the pipe of the livestock feed system, wherein the ozone supply line is connected to the pipe and is introducing ozone into the pipe that is being infused in the livestock feed as an augur of the augur system agitates the feed.

FIG. 8 is a cut-away front elevation view of a conventional livestock feed system having two augur systems connected to a hopper with livestock feed in transit through the livestock feed system.

FIG. 9A is a cut-away front elevation view of a livestock feed system of the system for sanitizing livestock feed with livestock feed in transit through the livestock feed system, wherein the livestock feed system includes a first augur system disposed within a first pipe that empties into a hopper and a second augur system that receives sanitized feed from the hopper, and wherein the feed is infused with ozone from an ozone supply line connected to the hopper and is also exposed to ultraviolet-C radiation from an ultraviolet-C light device installed in the hopper.

FIG. 9B is a cut-away top view of the livestock feed system of FIG. 9A.

FIG. 9C is a cut-away right side elevation view of the livestock feed system of FIG. 9A.

FIG. 10A is a cut-away side elevation view of a livestock feed system of the system for sanitizing livestock feed having a connected ozone infusion system that receives ozone from an ozone supply line connected thereto, wherein livestock feed is shown being infused with high pressure ozone.

FIG. 10B is a cut-away side elevation view of the livestock feed system of FIG. 10A, wherein the ozone infusion system is not in operation to agitate and infuse livestock feed with high pressure ozone.

FIG. 10C is a cut-away top plan view of the livestock feed system of FIG. 10A having a connected ozone infusion system connected to an ozone supply line.

FIG. 11 is a schematic view of a conventional livestock feed system.

FIG. 12 is a schematic view of one embodiment of a system for sanitizing livestock feed of the present invention.

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

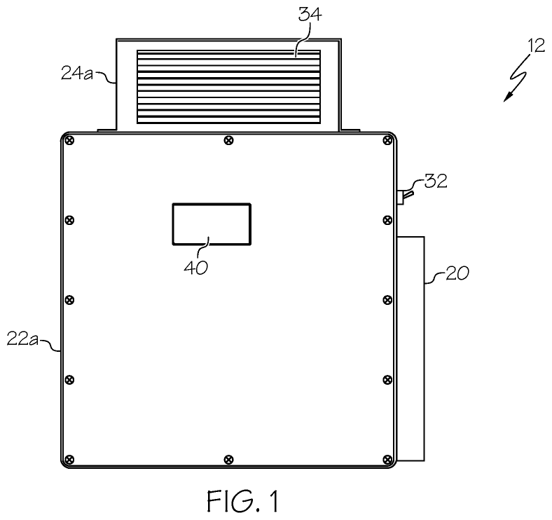

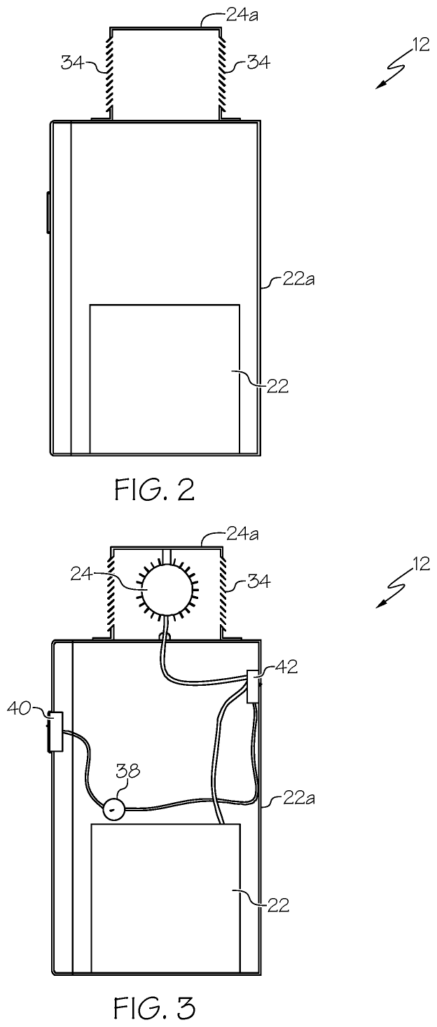

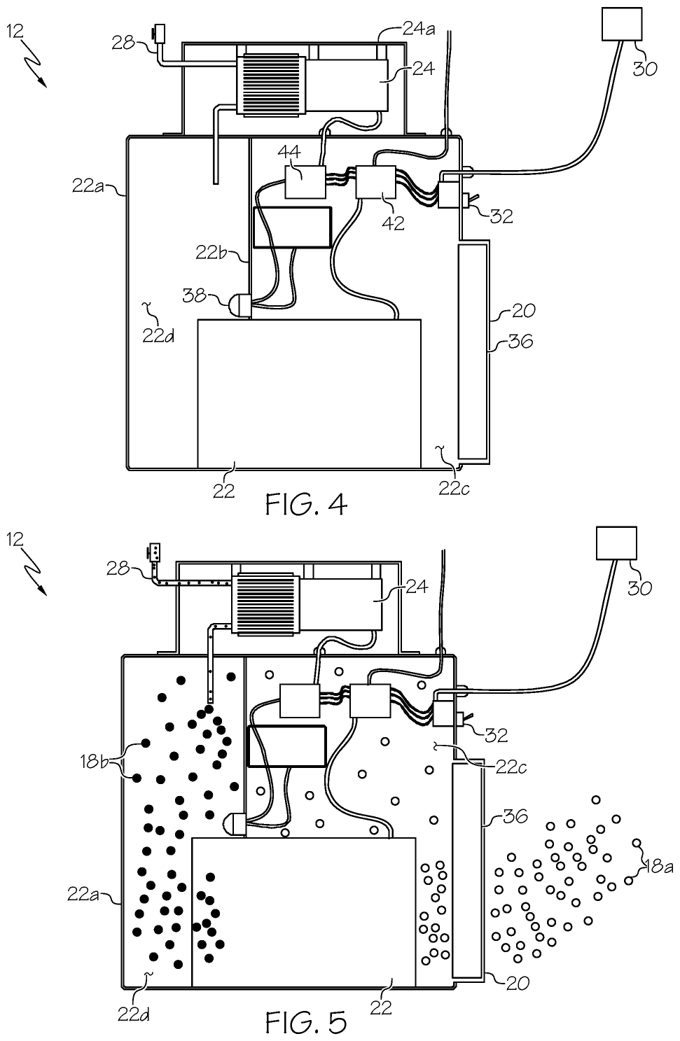

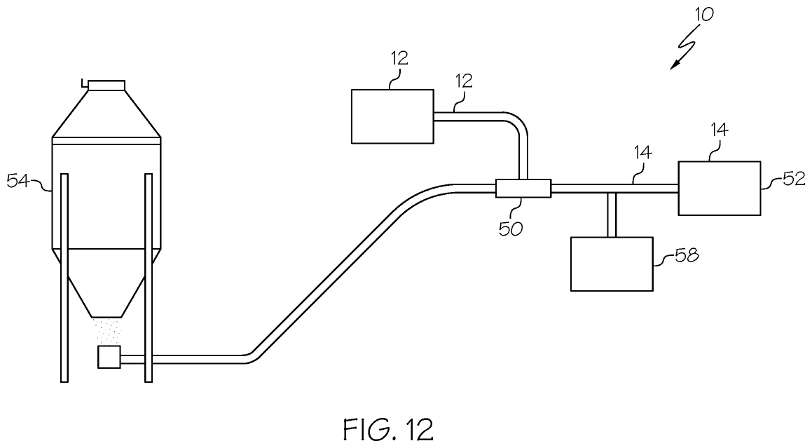

The invention provides a system for sanitizing livestock feed. As shown in FIG. 12, the system 10 for sanitizing livestock feed includes a device 12 for supplying a sanitizing gas and a livestock feed system 14. The device for supplying a sanitizing gas (also referred to herein as a sanitizing gas supply device 12) can be an ozone supply device 12. The ozone supply device 12, as shown in FIGS. 1-4, supplies ozone gas (O₃) or another sanitizing gas to the livestock feed system 14 to sanitize livestock feed 16 passing through the livestock feed system. An example of a conventional livestock feeding system is shown in FIG. 11. In some embodiments, a sanitizing gas other than ozone may be used, while in other embodiments, a combination of ozone and one or more other sanitizing gases may be used. For purposes of convenience, but not as a limitation, ozone 18b is referred to herein as the sanitizing gas 18b with the understanding that other sanitizing gases may be used in lieu of or in combination with ozone. Such other sanitizing gases may include water steam, chlorine-containing gases such as chlorine dioxide, and hydrogen peroxide. However, the use of ozone is preferred. The sanitizing gas supply device 12 may also be referred to herein as an ozone supply device 12 with the understanding that such device may supply ozone, one or more other sanitizing gases, or a combination of ozone and one or more other sanitizing gases.

The sanitizing gas supply device 12 supplies one or more sanitizing gases (e.g., ozone) to the livestock feed system 14 through which livestock feed is transported from a feed container to a feeding station. For example, the livestock feed system 14 can include an augur system or a conveyor system (e.g., an enclosed augur 46 or conveyor system from which gas cannot escape) for application to livestock feed, grain, produce (i.e., fruits and vegetables), other food items, and non-food items to sanitize such items.

Livestock feed 16 can be or can include one or more whole or milled grains (e.g., corn, oats, barley, and rice), legumes (e.g., soybeans), seeds (e.g., cottonseed), or mixtures thereof including parts thereof such as meal or hulls, silage, processed feeds, concentrates, or mixtures of two or more of the foregoing.

The ozone supply device 12 includes an intake port 20 for receiving air from outside the device 12, an ozone generator 22 for receiving air from the intake port and converting oxygen 18a in the air to ozone 18b, an ozone compressor intake 26 for receiving ozone produced by the ozone generator, a compressor pump 24 for compressing ozone received through the ozone compressor intake 24b, and an ozone supply line 28 for transmitting compressed ozone 18b to the livestock feed system 14 for application to livestock feed 16. In some embodiments, the compressor pump 24 is an air pump, e.g., a low pressure, high volume air pump. The compressor pump 24 also pumps the compressed ozone into and through the ozone supply line 28 so that the ozone is applied to, mixed with, or infused into livestock feed passing through the pipe 46 or other conduit of the livestock feed system 14 to which the ozone supply line is attached. Application of the compressed ozone 18b to the livestock feed 16 within the livestock feed system 14 sanitizes the livestock feed to kill pathogens such as bacteria, viruses, protozoa, and fungi. After ozone 18b is generated by the ozone generator 22, as shown in FIG. 5, the ozone is pulled through the ozone compressor intake 24b into the compressor pump 24 for compression and pumping into the ozone supply line 28.

The ozone supply device 12 also includes a power supply 30 for powering the ozone generator 22 and compressor pump 24. In exemplary embodiments, the power supply 30 is a utility power supply obtained by connection of a plug on a power cord to an outlet (i.e., an electrical socket). In other embodiments, the power supply 30 can be a generator, one or more batteries, or any other suitable power source. The ozone supply device 12 can include a power switch 32 that may be a separate switch or button operable to turn on and off the device.

The ozone supply device 12 can also include a first housing 22a inside which the ozone generator 22 is installed in whole or in part. In one embodiment, the first housing 22a includes a wall 22b that divides an interior space surrounded by the first housing into an oxygen chamber 22c and an ozone chamber 22d. The intake port 20 is located adjacent to the oxygen chamber 22c and passes through a wall of the first housing 22a into the oxygen chamber. The wall 22b separates the oxygen chamber 22c, which contains air containing oxygen (O₂) 18a, from the ozone chamber 22d, which contains ozone (O₃) 18b produced by the ozone generator 22 from oxygen (O₂) 18a that entered into the ozone generator from the oxygen chamber 22c. In exemplary embodiments, the first housing 22a includes four side walls and top and bottom walls enclosing an interior space in which the aforementioned components are installed.

The ozone supply device 12 can include a second housing 24a inside which the compressor pump 24 is installed in whole or in part. In one embodiment, the second housing 24a is attached to an exterior top wall of the first housing 22a. In one embodiment, the second housing 24a includes four side walls and a top wall that enclose an interior space in which the compressor pump 24 is installed. The four side walls may each include a flange that is connected to the top wall of the first housing 22a. In another embodiment, the second housing 24a includes four side walls and top and bottom walls enclosing an interior space in which the aforementioned components are installed. In this embodiment, the bottom wall of the second housing is connected to the top wall of the first housing. The second housing may include one or more vents 34.

The intake port 20 may include a dust filter 36 to remove dust and other particulates from the air before it enters into the ozone generator 22.

The ozone supply device 12 can include an ozone meter 38 to measure ozone concentration in the ozone chamber 22d of the first housing 22a. The ozone meter 38 can include or be connected to a display 40 that visually displays the ozone concentration of the air within the ozone chamber 22d. The display 40 is mounted on or through one of the side walls of the first housing 22a. The device's power switch 32 may be integrated into the display 40 in some embodiments.

The ozone supply device 12 can further include a timer 42 for controlling a length of time for which the device 12 runs to generate ozone before shutting off, or for controlling a start and end time at which the device turns on and turns off. In exemplary embodiments, the timer 42 can include both timer functions, i.e., running for a set period of time and turning on and off at preset times.

The ozone supply device 12 can further include an AC/DC inverter 44 to convert AC power from an outlet to DC power for use by electronic components of the device such as, for example, the timer 38 and the ozone meter 42. In one embodiment, the timer 42 is electrically connected to the power supply 30 and the power switch 32. Power is supplied through the timer 42 to the AC/DC inverter 44 and to the ozone generator 22, and power is supplied from the AC/DC inverter 44 to the compressor pump 24, the ozone meter 38, and the display 40.

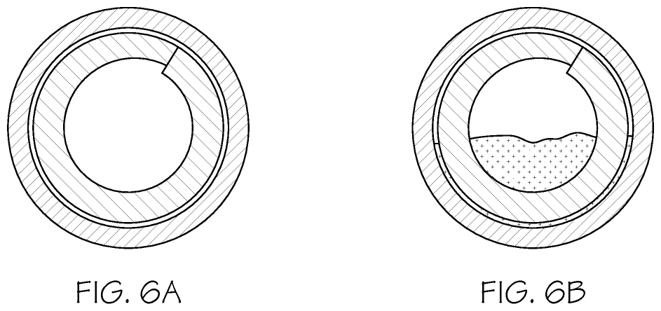

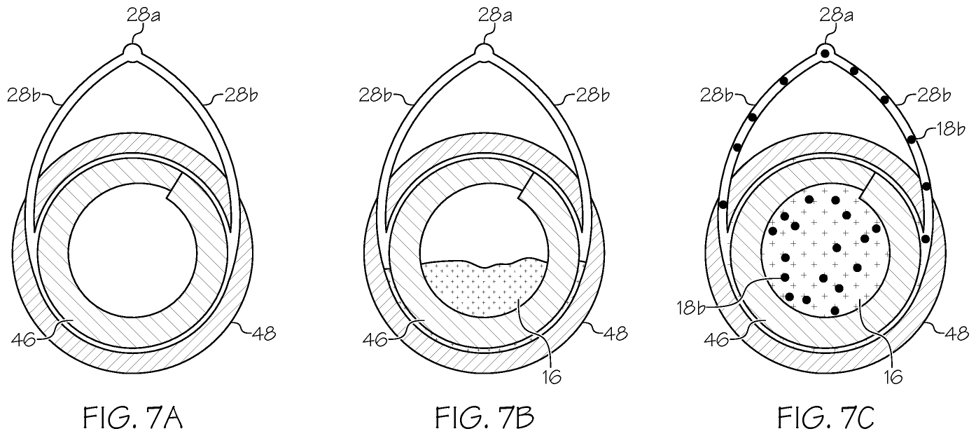

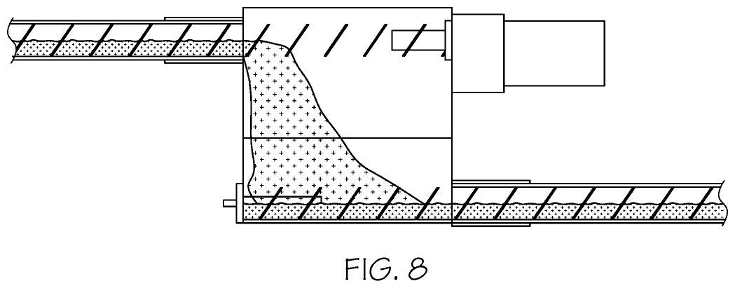

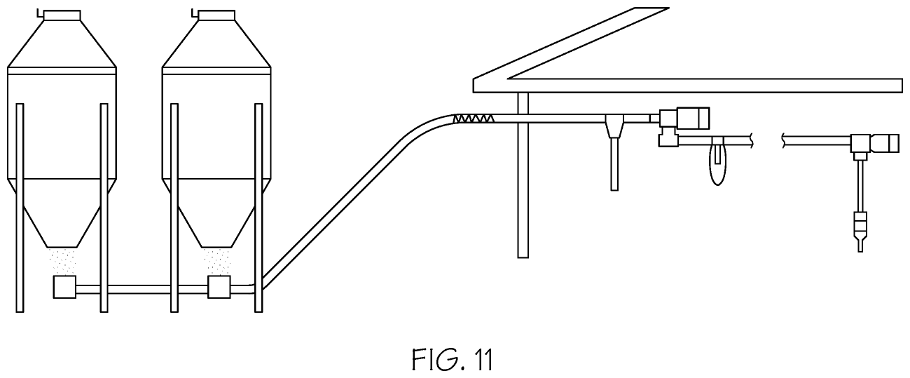

As shown in FIGS. 7A-7B and 10A-10C, the ozone supply device 12 is connected to the livestock feed system 14 by the ozone supply line 28. In one embodiment, the livestock feed system 14 can be, for example, an augur supply system that utilizes an augur 46 to move livestock feed 16 through a pipe 48 or other conduit 48. The augur 46 is a coil spring or screw type auger that, in addition to moving feed 16 through the livestock feed system 14, also agitates and exposes the feed to ozone 18b introduced into the pipe 48. The ozone supply line 28 includes a main line 28a from the compressor pump 24, from which two or more capillary lines 28b are communicatively connected to the pipe 48 of the livestock feed system 14 to inject ozone 18b into feed 16 being agitated by the augur 46 within the pipe. In some embodiments, the main line 28a runs parallel next to or in contact with the pipe 48 and has a plurality of capillary lines 28b that branch off of the main line 28a at intervals to pass through the pipe and into an interior space of the pipe to infuse livestock feed 16 passing therethrough with ozone 18b. For comparison, an augur system of a conventional livestock feed system, without a connected ozone supply line, is shown in FIGS. 6A-6B.

The pipe or pipes or other conduit or conduits 48 of the augur system can be opaque (e.g., white PVC) or clear. Where the capillary lines 28b of the ozone supply line 28 enter the augur system, a section of the pipe 48 may be removed and replaced with an adapter 50 or a connection section of pipe for connecting the capillary lines so that ozone is introduced from the ozone supply line into the pipe of the augur system to infuse livestock feed therein with ozone. The adapter 50 or connection section of pipe connects the ozone supply line 28 of the ozone supply device 12 to the conduit 48 of the livestock feed system 14. The adapter 50 may be a connection section of pipe or another coupling device. The adapter 50 or connection section of pipe may be constructed from the same material as the pipe 48 of the augur system or from a different material. For example, the adapter 50 or connection section of pipe may be clear to allow viewing of livestock feed as it is infused with ozone by the connected capillary lines 28b. In some embodiments, the adapter 50 or connection section of pipe may have connection ports or apertures preinstalled or predrilled through the connection section for connection of the capillary lines 28b. First and second couplers 62 may be installed over each end of the adapter 50 or connection section of pipe to attach each end securely to the two ends of the pipe 48 where the section was removed for replacement with the adapter or connection section.

In other embodiments, the pipe 48 of the augur system may be a unitary piece with no separate, added connection section. In such embodiments, the capillary lines 28b of the ozone supply line 28 are connected directly to the pipe 48 at ports or apertures passing through a wall of the pipe.

The invention also relates to a sanitization system for sanitizing livestock feed that includes a livestock feed system and an ozone supply device connected thereto. One example of a livestock feed system that may be incorporated in the sanitization system is shown in FIG. 11. The sanitizing gas supply device or ozone supply device is one as described herein above. In some embodiments of the system, a sanitizing gas other than ozone may be used, while in other embodiments, a combination of ozone and one or more other sanitizing gases may be used. For purposes of convenience, but not as a limitation, ozone is referred to herein as the sanitizing gas with the understanding that other sanitizing gases may be used with the system in lieu of or in combination with ozone. The sanitization system may also be referred to herein as an ozone sanitization system with the understanding that such system may supply ozone, one or more other sanitizing gases, or a combination of ozone and one or more other sanitizing gases. The sanitization system may also be used to supply one or more sanitizing gases (e.g., ozone) to an augur system or a conveyor system (e.g., an enclosed augur or conveyor system from which gas cannot escape) for application to livestock feed, grain, produce (i.e., fruits and vegetables), other food items, and non-food items to sanitize such items.

The livestock feed system 14 of the sanitization system 10 includes at least a first augur system disposed within at least a first pipe as shown in FIGS. 10A-10C. The augur 46 may be rigid or flexible and is turned within the interior space of the pipe 48 by an electric drive motor 52 to move livestock feed 16 from one or more bulk storage bins 54 or bulk feed tanks 54 to a hopper 56 or to a feeding station 58 such as, for example, an animal feeder or trough. The augur 46 is made from metal, plastic, or any other suitable material.

As shown in FIG. 8, some conventional livestock feed systems include a transitional hopper with a first augur system connected at a first connection port on the transitional hopper that is higher than a second connection port on the transitional hopper to which a second augur system is connected. An augur within the first augur system moves feed through a pipe so that the feed passes through the first connection port and falls inside the transitional hopper where another augur of the second augur system then moves the feed out of the transitional hopper and into a pipe of the second augur system to transport the feed to a feeding station.

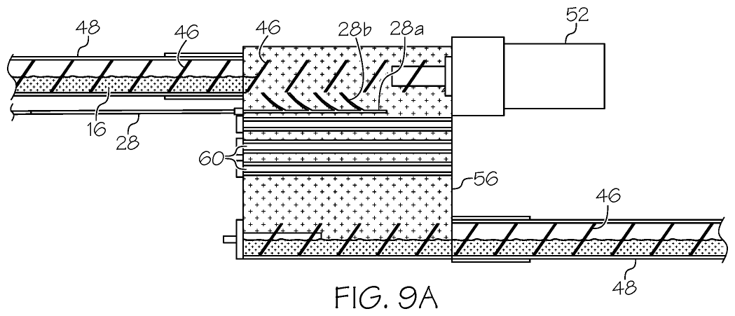

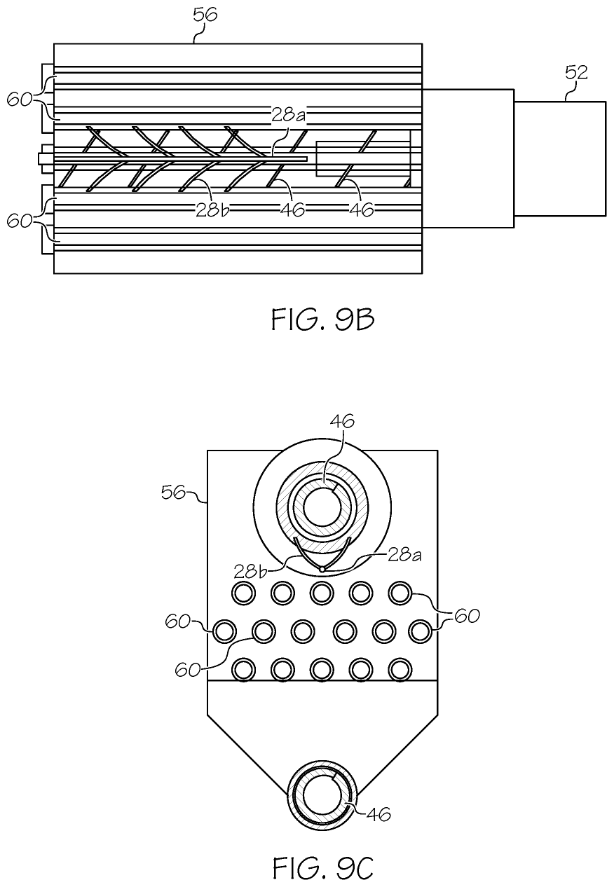

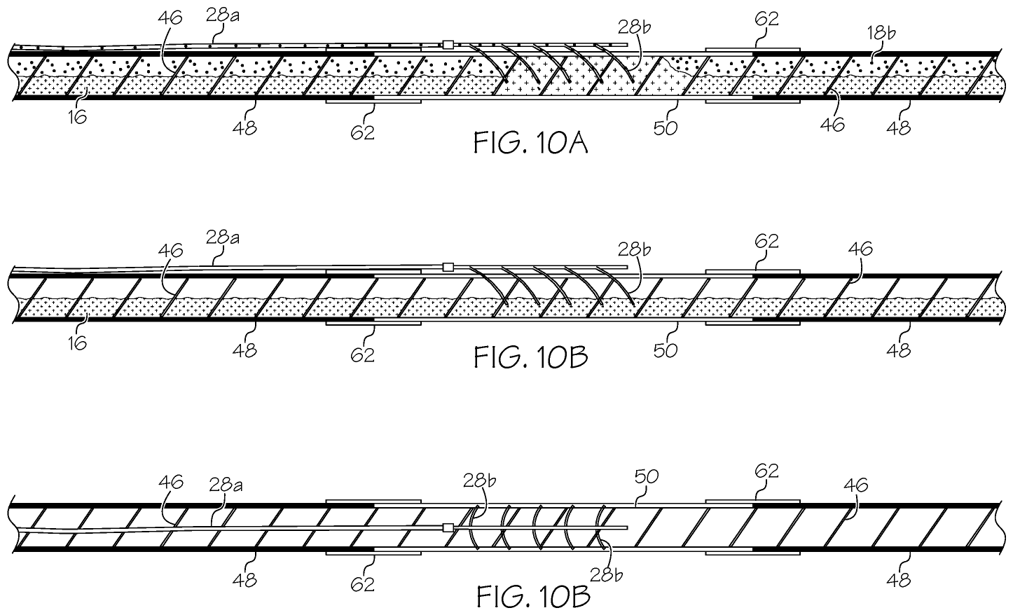

As shown in FIGS. 9A-9C, the livestock feed system 14 can include an ultraviolet-C light device 60 or other ultraviolet light-producing device 60 installed within an interior space inside a transitional hopper 56 to produce ultraviolet-C (UVC) radiation that irradiates the livestock feed 16 inside the transitional hopper for further sanitization. The ultraviolet-C light device 60 can include UVC lights 60 positioned at intervals within the transitional hopper 56 to provide maximum exposure of the feed passing therethrough to the UVC light. The UVC lights 60 may be installed inside glass or plastic sleeves to protect them from damage as feed passes through the transitional hopper 56. In some embodiments of this alternate embodiment, the ozone supply line 28 may be connected to the transitional hopper 56 so that compressed ozone is infused into the livestock feed as it falls out of the pipe 48 of the first augur system (having an augur 46) through the interior space of the transitional hopper to a bottom floor inside the transitional hopper for transport by an augur 46 of the second augur system out of the transitional hopper. In this manner, the livestock feed passing through the transitional hopper is both infused with ozone, which sanitizes the feed, and is exposed to UVC light, which also sanitizes the feed.

In other embodiments, the ozone supply line 28 can include capillary lines 28b that communicate with the pipe 48 of the first augur system, the pipe 48 of the second augur system, or both, as well as communicating with the transitional hopper 56. Alternatively, the ozone supply line may connect to one or more of augur systems' pipes only or to the transitional hopper only.

In still other embodiments like those described above, the ultraviolet-C light device may be omitted from the transitional hopper.

In some embodiments, the livestock feed system 14 of the system 10 for sanitizing livestock feed includes two or more augur systems. For example, in a livestock feed system 14 having two augur systems, each augur system can include a pipe or other conduit 48, an augur 46 installed within such pipe or other conduit, and a motor 52 for turning the augur. In one such embodiment, the livestock feed system 14 includes a first augur system, a second augur system, and a hopper. The first augur system has a pipe or other conduit 48 that transports livestock feed from a container 54 (e.g., a bulk container) and empties into a hopper 56 (e.g., a transitional hopper). The second augur system receives sanitized feed from the hopper and transports the sanitized livestock feed to a feeding station. The pipes or other conduits of the first and second augur systems are vertically separated from one another. For example, the pipe or conduit of the first augur system can be communicatively connected at or near a top portion of the hopper, e.g., through a top of the hopper or through a side wall of the hopper at or near a top portion of such side wall. An ozone supply line is connected to the pipe or conduit of the first augur system so that ozone is applied to, mixed with, or infused into livestock feed transported through the pipe or conduit. Such application, mixing, or infusion can occur within the pipe if the ozone supply line is connected to the pipe, or inside the hopper if the ozone supply line extends into the hopper, or both.

The invention also relates to a method of sanitizing livestock feed. The method includes the step of transporting livestock feed from a container through a conduit. This step may be accomplished using livestock feed systems such as those described elsewhere herein, although the method may also be performed using other types of livestock feed systems capable of transporting livestock feed from a container through a conduit. In a next step, the livestock feed is agitated as it passes through the conduit. This step of the method may be accomplished using one or more augur systems such as those described elsewhere herein. This step may also be accomplished, in part, using a hopper such as those described herein. In a next step, a sanitizing gas is applied to the livestock feed as it is agitated within the conduit to sanitize the livestock feed. Application of the sanitizing gas may involve emitting the gas onto an exposed surface or surfaces of the livestock feed as it passes through the conduit, mixing of ozone into the livestock feed as the feed is agitated, infusion of ozone into the livestock feed as it passes through and is agitated within the conduit, or other similar methods. This step of the method may be accomplished using an ozone supply device such as those described elsewhere herein. This step may also be accomplished using other devices that supply one or more sanitizing gases different from or in combination with ozone.

The method can also include the step of dispensing the sanitized livestock feed at a feeding station for consumption by an animal.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A system for sanitizing livestock feed, the system comprising:
an ozone supply device comprising:
an intake port for receiving oxygen from a source of oxygen (O₂);
an ozone generator for receiving the oxygen from the intake port and converting the oxygen to ozone;
an ozone compressor intake for receiving ozone produced by the ozone generator;
a compressor pump for compressing ozone received through the ozone compressor intake; and
an ozone supply line for transmitting compressed ozone to a livestock feed system for application to livestock feed;
a livestock feed system comprising:
a conduit for transporting livestock feed from a container to a feeding station; and
an agitating device installed within a pipe to agitate the livestock feed to increase infusion of ozone into the livestock feed for sanitization; and
an adapter that connects the ozone supply line of the ozone supply device to the conduit of the livestock feed system.

2. The system of claim 1, further comprising a filter installed over the intake port.

3. The system of claim 1, wherein the agitating device comprises an augur system; wherein the augur system comprises an augur installed inside the conduit; and wherein the augur is connected at a first end to a drive motor for rotating the augur within the conduit.

4. The system of claim 1, wherein the livestock feed system comprises a hopper; wherein the conduit comprises a first end and a second end; and wherein the conduit is connected at the first end to the container holding the livestock feed and at the second end to the hopper above an interior bottom surface of the hopper.

5. The system of claim 4, wherein a first end of the ozone supply line is communicatively connected to the compressor pump and a second end of the ozone supply line is communicatively connected to the hopper above the interior bottom surface of the hopper so that ozone is infused into the livestock feed as it exits the second end of the pipe and falls through an interior space of the hopper to the interior bottom surface.

6. The system of claim 1, further comprising ultraviolet lighting for sanitizing the livestock feed as it passes through the livestock feed system.

7. The system of claim 4, further comprising ultraviolet lighting for sanitizing the livestock feed as it passes through the livestock feed system; wherein the ultraviolet lighting is installed in the hopper.

8. A system for sanitizing livestock feed, the system comprising:
a livestock feed system for transporting livestock feed; and
an ozone supply device comprising:
an intake port for receiving air from outside the device;
an ozone generator for receiving air from the intake port and converting oxygen in the air to ozone;
an ozone compressor intake for receiving ozone produced by the ozone generator;
a compressor pump for compressing ozone received through the ozone compressor intake; and
an ozone supply line for transmitting compressed ozone into the livestock feed system for application to the livestock feed.

9. The system of claim 8, wherein the livestock feed system comprises an augur system installed within a pipe to turn and agitate the livestock feed; wherein the augur system comprises an augur installed inside the pipe; and wherein the augur is connected at a first end to a drive motor for rotating the augur.

10. The system of claim 8, wherein the livestock feed system applies the compressed ozone to the livestock feed as the livestock feed is agitated by the augur system.

11. The system of claim 8, wherein the ozone supply line comprises a main line and at least one capillary line; wherein the main line is connected at a first end to the compressor pump and extends generally in parallel along at least a portion of a pipe of the livestock feed system; and wherein each at least one capillary line communicatively connects at a first end to the main line and at a second end to the pipe of the livestock feed system.

12. The system of claim 11, wherein the at least one capillary line comprises a plurality of capillary lines, wherein the second end of each of the plurality of capillary lines communicatively connects to the pipe of the livestock feed system.

13. The system of claim 8, wherein compressed ozone is pumped from the compressor pump through a main line of the ozone supply line, from the main line into at least one capillary line, and from the at least one capillary line into a pipe of the livestock feed system for application to the livestock feed.

14. The system of claim 9, wherein the livestock feed system comprises a hopper; wherein the pipe of the augur system comprises a first end and a second end; and wherein the pipe is connected at the first end to the container holding the livestock feed and at the second end to the hopper above an interior bottom surface of the hopper.

15. The system of claim 14, wherein a first end of the ozone supply line is communicatively connected to the compressor pump and a second end of the ozone supply line is communicatively connected to the hopper above the interior bottom surface of the hopper so that ozone is infused into the livestock feed as it exits the second end of the pipe and falls through an interior space of the hopper to the interior bottom surface.

16. The system of claim 8, further comprising an adapter interconnecting between the livestock feed system and the ozone supply line of the ozone supply device for transmission of compressed ozone from the ozone supply line into the livestock feed system for application to the livestock feed as the livestock feed is agitated by an agitating device.

17. The system of claim 16, wherein the agitating device comprises an augur system comprising a pipe for transporting livestock feed from a container to a feeding station, an augur installed within the pipe, and a motor to turn the augur within the pipe to agitate the livestock feed for increasing infusion of the compressed ozone in the livestock feed.

18. The system of claim 8, further comprising ultraviolet lighting for sanitizing the livestock feed as it passes through the livestock feed system.

19. A method of sanitizing livestock feed, the method comprising the steps of:
(a) transporting livestock feed from a container through a conduit;
(b) agitating the livestock feed as it passes through the conduit; and
(c) applying a sanitizing gas to the livestock feed as it is agitated within the conduit to sanitize the livestock feed.

20. The method of claim 19, further comprising the step of:
(d) dispensing the sanitized livestock feed at a feeding station.
